(19) United States
(12) Patent Application Publication
(10) Pub. No.: US 2009/0041030 A1
(43) Pub. Date: Feb. 12, 2009

(54) Method for providing content service based on virtual channel in disk media playback apparatus

(75) Inventors: Wonjang Baek, Seongnam-si (KR); John Kim, Seoul (KR); Seong Baek Lee, Seoul (KR)

Correspondence Address: THE NATH LAW GROUP, 112 South West Street, Alexandria, VA, 22314, US

(73) Assignee: DREAMER INC., Seoul (KR)

(21) Appl. No.: 12/222,337

(22) Filed: Aug. 7, 2008

(30) Foreign Application Priority Data
Aug. 9, 2007 (KR) 10-2007-0079890

(51) Int. Cl. H04L 12/56

(52) U.S. Cl. 370/397

(57) ABSTRACT

A method for providing a content service based on a virtual channel in a disk media playback apparatus is disclosed. In accordance with the method of the present invention, an open content service is provided using the disk media playback apparatus to overcome drawbacks of a closed broadcasting service and wherein a virtual channel map is employed to support a selection of the content service of a viewer.

### BACKGROUND OF THE INVENTION

1. Field of the Invention

The present invention relates to a method for providing a content service based on a virtual channel in a disk media playback apparatus, and more particularly to a method for providing a content service based on a virtual channel in a disk media playback apparatus wherein an open content service is provided using the disk media playback apparatus to overcome drawbacks of a closed broadcasting service and wherein a virtual channel map is employed to support a selection of the content service of a viewer.

2. Description of the Related Art

A service provided by a conventional broadcasting service such a terrestrial broadcasting, a satellite broadcasting, a cable broadcasting and an IPTV is provided based a channel.

The channel represents a certain frequency. In case of the IPTV, the channel represents an identifier for a certain service.

A viewer inputs a number corresponding to the channel in order to receive the broadcasting service. The channel facilitates the reception of the broadcasting service.

However, a broadcasting service provider should make a large investment in order to provide the conventional broadcasting service. For instance, the broadcasting service provider should have a permit for broadcasting, equipments and broadcasting networks for a transmission of broadcasting signals. The broadcasting service provider should also have personnel for providing the broadcasting service.

In addition, as a transition from an analog broadcasting to a digital broadcasting is carried out, the broadcasting service provider should make more investments in order to provide the digital broadcasting.

Therefore, the conventional broadcasting service is provided by a large corporation or a public company having a large amount of funds in a closed manner.

On the other hand, an optical disk is a circular disk having thereon a data wherein an information of an audio or a video is converted into a digital code to be stored thereon. The data is read by measuring a strength of a reflective laser beam. The conventional optical disks includes a CD (Compact Disc), a DVD (Digital Versatile Disc) and an LD (laserdisc).

However, it is difficult to store a video data of a high capacity in the conventional optical disk as a HD (Hi-Definition) broadcasting is becoming popular. Therefore, a specification for a next generation optical disk is being developed.

A specification including a HD-DVD and a Blu-ray disk has been proposed as the next generation optical disk.

The HD-DVD follows a structure of the DVD to ensure a compatibility and also offers a definition higher than that of the DVD. The HD-DVD utilizes a blue laser having a wavelength of 405 nm instead of a red laser having a wavelength of 650 nm and has a capacity of 15 GB for a single layer disk and 30 GB for a dual layer disk.

While the Blu-ray disk uses the blue laser having the wavelength of 405 nm similar to the HD-DVD, the Blu-ray disk is advantageous over the HD-DVD in that the Blu-ray disk has the capacity of 25 GB for the single layer disk and 50 GB for the dual layer disk. Moreover, the Blu-ray disk is capable of having a quad-layer or an octa-layer wherein the capacity is expanded to 100 GB-200 GB.

Particularly, as the Blu-ray disk and the HD-DVD compliant to a specification of the next generation optical disk are popularized, an HD video is expected to be enjoyed easily, and a storage of a large amount of data is possible.

The conventional disk storage media stores the multimedia content such as a video data or an audio data, and the disk media playback apparatus reads and reproduces the multimedia content stored in the disk media.

### SUMMARY OF THE INVENTION

It is an object of the present invention to provide a method for providing a content service based on a virtual channel in a disk media playback apparatus wherein an open content service is provided using the disk media playback apparatus to overcome drawbacks of a closed broadcasting service and wherein a virtual channel map is employed to support a selection of the content service of a viewer.

In order to achieve above-described object of the present invention, there is provided a method for providing a content service based on a virtual channel in a disk media playback apparatus, the method comprising steps of: (a) configuring a virtual channel map for a plurality of the content services; (b) receiving a user input corresponding to a first content service, the first content service being one of the plurality of the content services; and (c) comparing the user input with the virtual channel map to provide the first content service.

Preferably, the step (a) comprises reading the virtual channel map stored in the disk media playback apparatus.

Preferably, the step (a) comprises reading the virtual channel map stored in a disk media inserted in the disk media playback apparatus

Preferably, the step (a) comprises receiving the virtual channel map via a communication connection to an external virtual channel map providing apparatus.

Preferably, the step (a) comprises receiving the virtual channel map via a communication connection to an external virtual channel map update information providing apparatus for providing an update information of the virtual channel map to update the virtual channel map.

Preferably, the virtual channel map comprises a service identification information for each of the plurality of the content services, a service identifier corresponding to the service identification information and a network identification information corresponding to the service identifier.

Preferably, the service identifier is uniquely assigned to each of the plurality of the content services.

Preferably, the step (b) comprises: (b-1) displaying the virtual channel map on a display apparatus connected to the disk media playback apparatus; and (b-2) receiving the user input corresponding to the first content service.

Preferably, the virtual channel map comprises a service identification information for each of the plurality of the content services, a service identifier corresponding to the service identification information and a network identification information corresponding to the service identifier, wherein the step (b-1) comprises displaying the service identification information and a selection user interface corresponding to the service identification information, and wherein the step (b-2) comprises receiving the user input for the selection user interface.

Preferably, the virtual channel map comprises a service identification information for each of the plurality of the content services, a service identifier corresponding to the service identification information and a network identification information corresponding to the service identifier, wherein the step (b-1) comprises displaying the service identification information and the service identifier, and wherein the step (b-2) comprises receiving the service identifier as the user input.

Preferably, the step (b) comprises: (b-1) generating a preferred virtual channel map based on the virtual channel map, the preferred virtual channel map corresponding to a portion of the plurality of the content services; (b-2) displaying the preferred virtual channel map on a display apparatus connected to disk media layback apparatus; and (b-3) receiving the user input corresponding to the first content service based on the preferred virtual channel map.

Preferably, the preferred virtual channel map comprises a service identification information for each of the portion of the plurality of the content services, a service identifier corresponding to the service identification information and a network identification information corresponding to the service identifier, wherein the step (b-2) comprises displaying the service identification information and a selection user interface corresponding to the service identification information, and wherein the step (b-3) comprises receiving the user input for the selection user interface.

Preferably, the step (b-2) comprises displaying a selection user interface for each of the portion of the plurality of the content services included in the preferred virtual channel map, the selection user interface having a form of an icon, and wherein the step (b-3) comprises receiving the user input for the selection user interface.

Preferably, the step (b) comprises: (b-1) providing a search interface for the plurality of the content services in the virtual channel map; (b-2) receiving a search input through the search interface; (b-3) displaying the content service extracted from the plurality of the content services in the virtual channel map, the extracted content service corresponding to the search input; and (b-4) receiving the user input corresponding to the extracted content service.

Preferably, the step (c) comprises: (c-1) extracting a network identification information from the virtual channel map for establishing a communication connection to an external content service providing apparatus providing the first content service; (c-2) establishing the communication connection to the external content service providing apparatus based on the network identification information; (c-3) receiving the first content service from the external content service providing apparatus; and (c-4) processing and providing the first content service.

### BRIEF DESCRIPTION OF THE DRAWINGS

FIG. 1 is a diagram illustrating a system environment wherein a method for providing a content service based on a virtual channel in a disk media playback apparatus in accordance with the present invention is applied.

FIG. 2 is a flow diagram exemplifying a method for providing a content service based on a virtual channel in a disk media playback apparatus in accordance with the present invention.

### DETAILED DESCRIPTION OF THE INVENTION

A method for providing a content service based on a virtual channel in a disk media playback apparatus in accordance with the present invention will be described with reference to accompanied drawings.

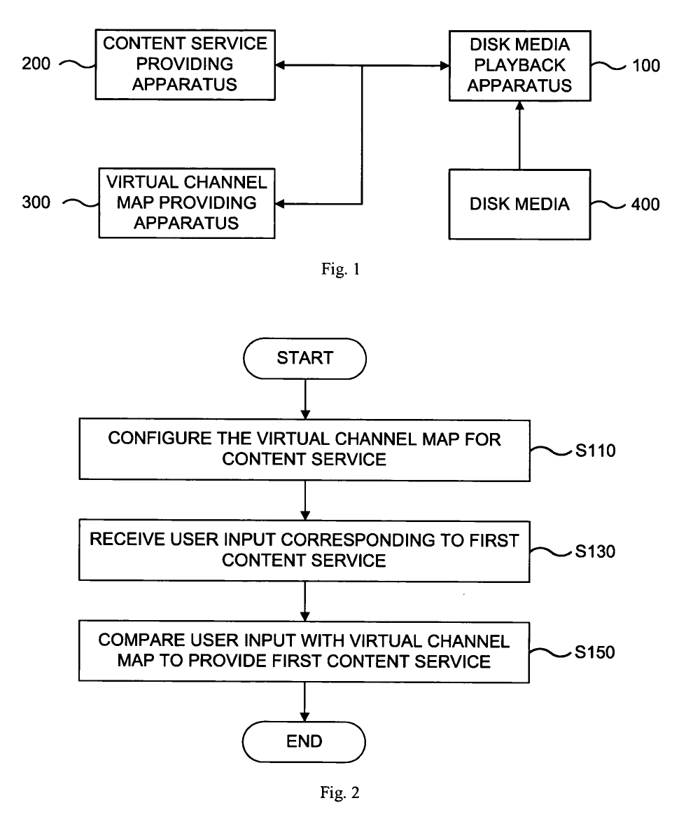

FIG. 1 is a diagram illustrating a system environment wherein a method for providing a content service based on a virtual channel in a disk media playback apparatus in accordance with the present invention is applied.

Referring to FIG. 1, the system environment wherein the method for providing the content service based on the virtual channel in the disk media playback apparatus in accordance with the present invention is applied comprises a disk media playback apparatus 100 and a content service providing apparatus 200. In addition, the system environment may further comprise a virtual channel map providing apparatus 300 or a disk media 400.

The method for providing the content service based on the virtual channel in the disk media playback apparatus in accordance with the present invention is embodied in the disk media playback apparatus 100. The disk media playback apparatus 100 reads the disk media 400 and reproduces a content stored in the disk media 400.

In accordance with the present invention, the disk media playback apparatus 100 provides the content service via a communication connection to the content service providing apparatus 200 based on a virtual channel map.

The virtual channel map stores an information for the communication connection to the content service providing apparatus 200. A “virtual channel”, which completely differs from a conventional broadcasting channel, hereinafter refers to an information for receiving the content service.

In addition, the content may be a multimedia content such as a video stream, a game or a data application for providing information. The content service refers to a service for providing the content through the disk media playback apparatus 100.

The disk media 400 may be a HD-DVD or a Blu-ray disk as well as a DVD. The disk media playback apparatus 100 may be a HD-DVD player, a Blu-ray player or a DVD player.

The content service providing apparatus 200 stores a plurality of multimedia contents and provides at least one of the plurality of multimedia contents to the disk media playback apparatus 100 via a communication network. That is, the content service providing apparatus 200 stores the multimedia contents and provides the multimedia content to the disk media playback apparatus 100 according to a request from the disk media playback apparatus 100.

While single content service providing apparatus 200 is shown in FIG. 1, a plurality of the content service providing apparatus may be employed according to content service providers.

The virtual channel map providing apparatus 300 provides the virtual channel map, which is a base information for establishing the communication connection between the disk media playback apparatus 100 and the content service providing apparatus 200, to the disk media playback apparatus 100.

On the other hand, the virtual channel map may be stored in the disk media playback apparatus 100 separately or be stored in the disk media 400.

### MODE FOR INVENTION

The method for providing the content service based on the virtual channel in the disk media playback apparatus in accordance with the present invention applied to the system environment of FIG. 1 is described below in detail.

FIG. 2 is a flow diagram exemplifying the method for providing the content service based on the virtual channel in the disk media playback apparatus in accordance with the present invention.

The disk media playback apparatus 100, wherein the method for providing the content service based on the virtual channel in the disk media playback apparatus is embodied, configures the virtual channel map for the plurality of the content services (S110).

The virtual channel map includes a list of information on the content service that may be received by the disk media playback apparatus 100 via the communication network.

In one embodiment, the virtual channel map may comprise a service identification information for each of the plurality of the content services, a service identifier corresponding to the service identification information and a network identification information corresponding to the service identifier.

For instance, when The National Broadcasting Company provides a traffic information service and The American Broadcasting Company provides a news service, the service identification information for each of the services may be assigned as “NBC” and “ABC”. That is, the service identification information may correspond to a name of the broadcasting company for the conventional broadcasting service. In case of other content providers, a text string that may identify the content providers may be used.

In addition, the service identification information may include a description for the corresponding service. That is, in case of the traffic information service, the service identification information may be assigned as “NBC-traffic information”. In case of the news service, the service identification information may be assigned as “ABC-news”. The description may be used when a viewer carries out a search for the content service.

The service identifier corresponding to the service identification information may be assigned to a text or a number such as “1111” for the service identification information assigned as “NBC-traffic information” and “1112” for the service identification information assigned to “ABC-news”.

The service identifier corresponds to a channel number in the conventional broadcasting service. That is, similar to NBC using a channel 9 and ABC using a channel 11, the content service corresponding to the service identification information “NBC-traffic information” uses the service identifier “1111” and the content service corresponding to the service identification information “ABC-news” uses the service identifier “1112”.

However, the service identifier may be uniquely assigned to each of the plurality of the content services. For instance, when a phone number of the content provider is used as the service identifier, the service identification information may be uniquely provided for each of the plurality of the content services. Alternately, other numbers may be assigned to the service identifier.

When the phone number of the content provider is used as the network identification information, non-duplicate service identifiers may be obtained without requiring an organization for the assignment of the service identifier. The service identifier may be defined to include a country code and an area code such as +82-2-2026-1600 to guarantee the uniqueness of the service identifier.

The network identification information is for receiving each of the content services. The network identification information corresponding to the service identification information “NBC-traffic information” may be an URL information of the content service providing apparatus 200 that provides traffic information service of the National Broadcasting Company.

The virtual channel map may be configured in various ways.

The virtual channel map may be stored in the disk media playback apparatus 100 in advance. The disk media playback apparatus 100 may configure the virtual channel map by merely reading the virtual channel map stored therein in advance.

The virtual channel map may also be recorded on the disk media 400. When the user may insert the disk media 400 into the disk media playback apparatus 100, the disk media playback apparatus 100 reads the virtual channel map to configure the virtual channel map.

Alternately, the disk media playback apparatus 100 may receive the virtual channel map from the virtual channel map providing apparatus 300 via a communication connection to the virtual channel map providing apparatus 300. That is, as shown in FIG. 1, the disk media playback apparatus 100 establishes the communication connection to the external virtual channel map providing apparatus 300 for storing the virtual channel map to receive the virtual channel map. The disk media playback apparatus 100 then configures the virtual channel map.

When the virtual channel map is received through communication connection to the virtual channel map providing apparatus 300, the disk media playback apparatus 100 may have the network identification information of the virtual channel map providing apparatus 300 in advance, obtain the network identification information of the virtual channel map providing apparatus 300 from a user input or read the disk media 400 to obtain the network identification information of the virtual channel map providing apparatus 300 stored in the disk media 400.

On the other hand, even after the virtual channel map is configured, the disk media playback apparatus 100 may update the virtual channel map.

That is, the disk media playback apparatus 100 may update the virtual channel map configured in the step S110 through a communication connection to an external virtual channel map update information providing apparatus (not shown). The virtual channel map update information providing apparatus may be included in the virtual channel map providing apparatus 300.

When the configuration of the virtual channel map is complete in the step S110, the disk media playback apparatus 100 then receives a user input corresponding to a first content service which is one of the plurality of the content services (S130).

The user who wishes to be provided with a certain content service, i.e. the first content service, generates a user input for the first content service using a remote control of the disk media playback apparatus 100, and the disk media playback apparatus 100 receives the user input.

The user input corresponding to the first content service may be the service identifier.

That is, the user inputs the service identifier through the remote control of the disk media playback apparatus 100 and the disk media playback apparatus 100 receives the service identifier.

For instance, the user may press a specific button on the remote control designated for providing the content service and input the service identifier.

When the user does not know the service identifier, the disk media playback apparatus 100 may display the service identification information and the service identifier on a display apparatus (not shown) connected to the disk media playback apparatus 100 using the virtual channel map in order to assist the user with the selection, and then receive the user input corresponding to the first content service.

When the service identifier is excessively long, it is inconvenient for the user to input the service identifier. In such case, the disk media playback apparatus 100 may display the virtual channel map on the display apparatus (not shown) connected to the disk media playback apparatus 100, and then receive the user input corresponding to the first content service of the plurality of content services.

When the virtual channel map includes the service identification information for each of the plurality of the content services, the service identifier corresponding to the service identification information and the network identification information corresponding to the service identifier, the disk media playback apparatus 100 displays the service identification information and a selection user interface, which is for the selection by the user, corresponding to the service identification information, and then receives the selection of the content service by the user through the selection user interface.

The selection user interface allows the user to select the content service using an arrow button or a numeric key button of the remote control. The disk media playback apparatus 100 receives the selection of the content service of the user as the user input through the selection user interface.

The virtual channel map provides the service identification information, the service identifier and the network identification information for the plurality of content services.

However, the content services frequently used by the user may be limited. Therefore, the disk media playback apparatus 100 may generate a preferred virtual channel map based on the virtual channel map configured in the step S110 and receive the user input based on the preferred virtual channel map.

That is, the disk media playback apparatus 100 may generate the preferred virtual channel map corresponding to a portion of the plurality of the content services, display the preferred virtual channel map on the display apparatus (not shown) connected to the disk media playback apparatus 100, and then receive the user input corresponding to the first content service of the preferred virtual channel map.

The preferred virtual channel map may comprise the service identification information of each of the portion of portion of the plurality of the content services, the service identifier corresponding to the service identification information and the network identification information corresponding to the service identifier.

When the preferred virtual channel map is used, the disk media playback apparatus 100 displays the service identification information the selection user interface, which is for the selection by the user, corresponding to the service identification information, and then receives the selection of the content service by the user through the selection user interface.

The selection user interface allows the user to select the content service using the arrow button or the numeric key button of the remote control. The disk media playback apparatus 100 receives the selection of the content service of the user as the user input through the selection user interface.

Alternately, the disk media playback apparatus 100 may display the selection user interface having a form of an icon for each of the portion of the plurality of the content services included in the preferred virtual channel map and receive the user input for the selection user interface through the selection user interface having the form of the icon. The selection user interface having the form of the icon allows the user to intuitively select the content service.

For instance, when an icon corresponding to a new information is stored in the disk media playback apparatus 100 or the disk media 400, the disk media playback apparatus 100 may display an news icon to correspond to a news information service included in the preferred virtual channel map of the news informations provided by a plurality of the content providers. The user may select the news information service included in the preferred virtual channel map through the news icon.

On the other hand, when the plurality of the content service can be provided, the disk media playback apparatus 100 may provide the user with a search interface. The virtual channel map may include the description of the content service in the service identification information in order to provide the search interface.

Alternately, the virtual channel map may include an additional information in a text format for the service identification information. The disk media playback apparatus 100 may display the search interface and the receive receiving a search input of the user through the search interface. For instance, the search input may be text strings representing a characteristic of the content service such as “news”. Thereafter, the disk media playback apparatus 100 displays the content service extracted from the plurality of the content services in the virtual channel map which corresponds to the search input, and receive the user input corresponding to the extracted content service.

When the user input is received in the step S130, the disk media playback apparatus 100 compares the user input with the virtual channel map to provide the first content service (S150).

Specifically, the disk media playback apparatus 100 extracts the network identification information for the communication connection to the external content service providing apparatus 200 which provides the content service corresponding to the selection of the user. The network identification information may be included in the virtual channel map.

When the network identification information is extracted, the disk media playback apparatus 100 establishes the communication connection to the content service providing apparatus 200 based on the network identification information.

Thereafter, the disk media playback apparatus 100 receives the first content service from the content service providing apparatus 200 and process the received content service to be provided through the display apparatus.

As described above, in accordance with the present invention, the open content service is provided using the disk media playback apparatus to overcome drawbacks of the closed broadcasting service and the virtual channel map is employed to support the selection of the content service of the viewer.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A method for providing a content service based on a virtual channel in a disk media playback apparatus, the method comprising steps of:
(a) configuring a virtual channel map for a plurality of the content services;
(b) receiving a user input corresponding to a first content service, the first content service being one of the plurality of the content services; and
(c) comparing the user input with the virtual channel map to provide the first content service.

2. The method in accordance with claim 1, wherein the step (a) comprises reading the virtual channel map stored in the disk media playback apparatus.

3. The method in accordance with claim 1, wherein the step (a) comprises reading the virtual channel map stored in a disk media inserted in the disk media playback apparatus

4. The method in accordance with claim 1, wherein the step (a) comprises receiving the virtual channel map via a communication connection to an external virtual channel map providing apparatus.

5. The method in accordance with claim 1, wherein the step (a) comprises receiving the virtual channel map via a communication connection to an external virtual channel map update information providing apparatus for providing an update information of the virtual channel map to update the virtual channel map.

6. The method in accordance with claim 1, wherein the virtual channel map comprises a service identification information for each of the plurality of the content services, a service identifier corresponding to the service identification information and a network identification information corresponding to the service identifier.

7. The method in accordance with claim 6, wherein the service identifier is uniquely assigned to each of the plurality of the content services.

8. The method in accordance with claim 1, wherein the step (b) comprises:
(b-1) displaying the virtual channel map on a display apparatus connected to the disk media playback apparatus; and
(b-2) receiving the user input corresponding to the first content service.

9. The method in accordance with claim 8, wherein the virtual channel map comprises a service identification information for each of the plurality of the content services, a service identifier corresponding to the service identification information and a network identification information corresponding to the service identifier,
wherein the step (b-1) comprises displaying the service identification information and a selection user interface corresponding to the service identification information, and
wherein the step (b-2) comprises receiving the user input for the selection user interface.

10. The method in accordance with claim 8, wherein the virtual channel map comprises a service identification information for each of the plurality of the content services, a service identifier corresponding to the service identification information and a network identification information corresponding to the service identifier,
wherein the step (b-1) comprises displaying the service identification information and the service identifier, and
wherein the step (b-2) comprises receiving the service identifier as the user input.

11. The method in accordance with claim 10, wherein the step (b) comprises:
(b-1) generating a preferred virtual channel map based on the virtual channel map, the preferred virtual channel map corresponding to a portion of the plurality of the content services;
(b-2) displaying the preferred virtual channel map on a display apparatus connected to disk media layback apparatus; and
(b-3) receiving the user input corresponding to the first content service based on the preferred virtual channel map.

12. The method in accordance with claim 11, wherein the preferred virtual channel map comprises a service identification information for each of the portion of the plurality of the content services, a service identifier corresponding to the service identification information and a network identification information corresponding to the service identifier,
wherein the step (b-2) comprises displaying the service identification information and a selection user interface corresponding to the service identification information, and
wherein the step (b-3) comprises receiving the user input for the selection user interface.

13. The method in accordance with claim 11, wherein the step (b-2) comprises displaying a selection user interface for each of the portion of the plurality of the content services included in the preferred virtual channel map, the selection user interface having a form of an icon, and
wherein the step (b-3) comprises receiving the user input for the selection user interface.

14. The method in accordance with claim 1, wherein the step (b) comprises:
(b-1) providing a search interface for the plurality of the content services in the virtual channel map;
(b-2) receiving a search input through the search interface;
(b-3) displaying the content service extracted from the plurality of the content services in the virtual channel map, the extracted content service corresponding to the search input; and
(b-4) receiving the user input corresponding to the extracted content service.

15. The method in accordance with claim 1, wherein the step (c) comprises:
(c-1) extracting a network identification information from the virtual channel map for establishing a communication connection to an external content service providing apparatus providing the first content service;
(c-2) establishing the communication connection to the external content service providing apparatus based on the network identification information;
(c-3) receiving the first content service from the external content service providing apparatus; and
(c-4) processing and providing the first content service.
